(19) United States
(12) Patent Application Publication
(10) Pub. No.: US 2002/0071281 A1
(43) Pub. Date: Jun. 13, 2002

(54) Lamp shade cover with exterior seam

(76) Inventor: Gertrude L. Dickson, Altadena, CA (US)

Correspondence Address: SHELDON & MAK, 225 South Lake Avenue, Suite 900, Pasadena, CA, 91101, US

(21) Appl. No.: 09/733,308

(22) Filed: Dec. 8, 2000

(51) Int. Cl. F21V 1/00; F21V 1/26

(52) U.S. Cl. 362/351; 362/357; 493/950

(57) ABSTRACT

A lamp shade slip cover is a continuous loop of material constructed from a flexible panel having a first surface, a second surface, a top edge, a bottom edge and opposed first and second sides. The first and second sides have respective first and second side edges. The first and second side edges are joined to one another along a vertical seam. The vertical seam comprises a five-layer stack consisting of a single fold of the first side (having two layers) and a double fold of the second side (having three layers).

### FIELD OF THE INVENTION

This invention relates generally to lamp shades and, more specifically, to slip cover for lamp shades.

### BACKGROUND OF THE INVENTION

Lamp shades for table and floor lamps are found in virtually every home in the United States. Lamp shades not only provide the functional benefit of shading the occupant from the harsh glare of an incandescent light bulb, but also provides important aesthetic benefits.

Unfortunately, lamp shades are relatively expensive, and so it is not practical to frequently replace lamp shades to alter and upgrade the homeowner's decor.

A slip cover for lamp shades would solve this problem by providing an inexpensive way to change and upgrade the aesthetic “look” of one's lamp shades. Unfortunately, prior slip cover designs fail to smoothly conform to the exterior of the lamp shade. The slip cover material tends to wrinkle and show lumps. Also, the one or more vertical seams used in slip covers of the prior art tend to pucker.

Accordingly, there is a need for a lamp shade slip cover which avoids the aforementioned problems with the prior art and is yet practical and inexpensive to manufacture.

### SUMMARY OF THE INVENTION

The invention satisfies this need. The invention is a lamp shade slip cover comprising a continuous loop of material, the continuous loop of material comprising a flexible panel having a first surface, a second surface, a top edge, a bottom edge and opposed first and second sides having respective first and second side edges, the first and second side edges being joined to one another along a first vertical seam, the loop having an upper opening defining a first open area and a lower opening defining a second open area, the first open area being less than the second open area, the first vertical seam being formed by (i) disposing the first surface of the two opposed side edges in abutment to form a seam allowance, (ii) sewing through the seam allowance to join the two side edges together, (iii) folding the second side over the seam allowance so as to sandwich the seam allowance between the first and second sides and to form a four layer stack; (iv) sewing through the four layer stack to form a French seam, and (v) folding the second side back over the French seam and sewing the second side to the French seam to form a five layer stack.

### DESCRIPTION OF THE DRAWINGS

These and other features, aspects and advantages of the present invention will become better understood with reference to the following description, appended claims and accompanying drawings where:

FIG. 1 is an isometric view of a lamp shade slip cover having features of the invention;

FIG. 2 is a plan view of a slip shade material useable in the manufacture of the invention;

FIG. 3 is a cross-sectional side view of a vertical seam found in slip covers of the prior art;

FIG. 4A is a cross-sectional side view illustrating a first step in the preparation of the vertical seam used in the embodiment illustrated in FIG. 1, taken along line 4-4;

FIG. 4B is a cross-sectional side view illustrating a second step in the preparation of the vertical seam used in the embodiment illustrated in FIG. 1, taken along line 4-4;

FIG. 4C is a cross-sectional side view illustrating a third step in the preparation of the vertical seam used in the embodiment illustrated in FIG. 1, taken along line 4-4; and

FIG. 5 is an isometric view of a second embodiment of a lamp shade slip cover having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a lamp shade slip cover 10. The lamp shade slip cover 10 comprises a continuous loop of material 12 including a flexible panel 14 having a first surface 10 16, a second surface 18, a top edge 20, a bottom edge 22 and opposed first and second sides 24 and 26, respectively. In the embodiments illustrated in the drawings, the first side 24 of the panel 14 is the interior side and the second side 26 of the panel 14 is the exterior side.

The first side 24 terminates in a first side edge 28 and the second side 26 terminates in a second side edge 30. The first side edge 28 and the second side edge 30 are joined to one another along a first vertical seam 32.

The panel 14 can be made from any suitably flexible material. The panel 14 should be sufficiently flexible to drape smoothly over the exterior of a lamp shade 34 and to conform to the contours of the lamp shade 34. In a typical embodiment, the panel 14 is made from a woven cloth.

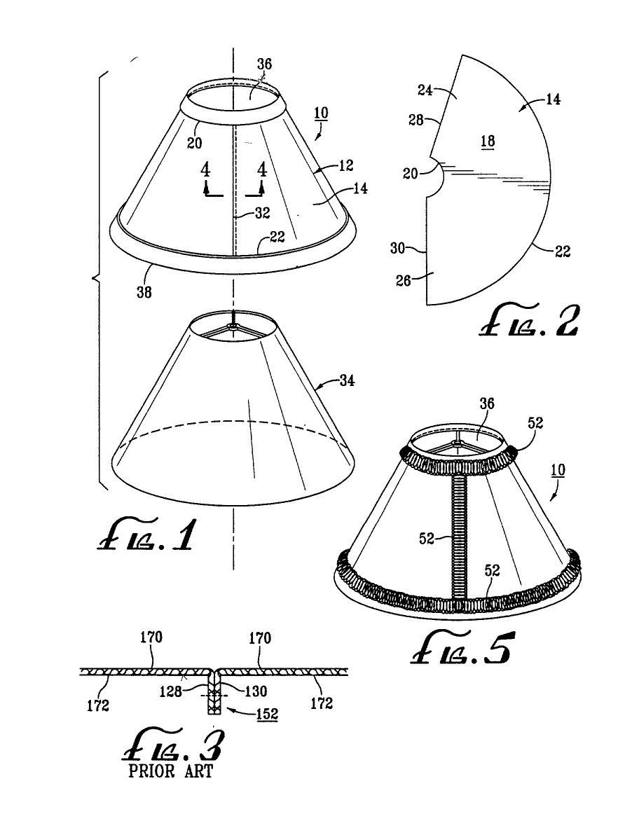

FIG. 2 illustrates a panel 14 used in the assembly of the slip cover 10 illustrated in FIG. 1. In this embodiment, the slip cover 10 has a frustoconical shape. This embodiment is designed to conform to a lamp shade 34 having a similar frustoconical shape, such as illustrated in FIG. 1. Those of ordinary skill in the art will appreciate that the panel 14 illustrated in FIG. 2 can be easily modified to create lamp shade slip covers 10 having a variety of other shapes.

The top edge 20 defines an upper opening 36 and the bottom edge 22 defines a lower opening 38. The upper opening 36 has a first open area and the lower opening 38 has a second open area. In a typical embodiment, the first open area is smaller than the second open area. The top edge 20 of the panel 14 is preferably folded flat against the exterior surface of the panel 14 and sewn thereto. It is also typical that the bottom edge 22 of the panel 14 is folded flat against the exterior of the surface of the panel 14 and sewn thereto.

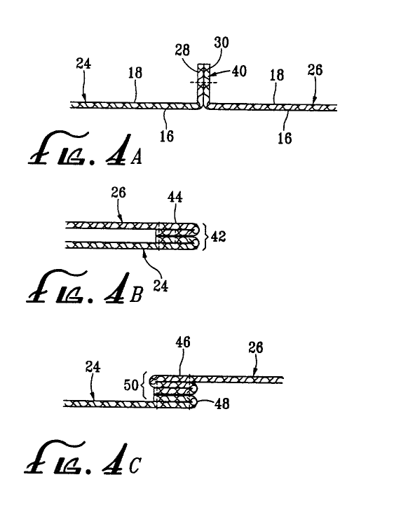

In lamp shade slip covers of the prior art, the vertical seam 132 is made by disposing the exterior surfaces 170 of the first and second side edges 128 and 130, respectively, together and sewing the first side edge 128 to the second side edge 130 using stitches disposed into the interior sides 172 of the first and second side edges 128 and 130. Such prior art vertical seam 132 is illustrated in FIG. 3 and is contrasted with the construction of the vertical seam 32 in the invention, as illustrated in FIG. 4.

In the vertical seam 32 of the invention, the first surface 16 of the two opposed side edges 28 and 30 are disposed in abutment to form a seam allowance 40. The seam allowance 40 is then sewn by stitches disposed between the second surfaces 18 of the two opposed side edges 28 and 30. Next, the second side 26 is folded over the seam allowance 40 to form a four layer stack 42. Next the four layer stack is sewn together by stitches disposed between the two first surfaces 16 to form a French seam 44. Finally, the second side 26 is folded over the French seam 44 and sewn to the French seam 44. As can be seen in FIG. 4, the first vertical seam 32 thereby comprises a five-layer stack 46 comprising a single fold 48 of the first side 24 (which provides two layers of the five-layer stack 46) and a double fold 50 of the second side 26 (which provides three layers of the five-layer stack).

Typically, the first side 24 of the panel 14 is the interior side of the panel 14 and the second side 26 of the panel 14 is the exterior side of the panel 14. However, this is not necessary.

It will be appreciated by those of skill in the art that FIG. 4 exaggerates the thickness of the completed vertical seam 32. In reality, the vertical seam 32 is relatively thin. It has been found that the use of a vertical seam 32 having such unique five-layer construction provides an unusually smooth surface along the interior side of the flexible panel 14. This smoothness of the interior side of the flexible panel 14 allows the slip cover 10 of the invention to conform smoothly to the contours of the exterior surface of a lamp shade 34. It is the use of the unique vertical seam 32 having the aforedescribed five-layer construction which allows the slip cover 10 of the invention to avoid the previously-described problems with the prior art.

In alternative designs, not illustrated in the drawings, the slip cover 10 comprises a plurality of vertical seams 32. In such alternative embodiments, all vertical seams 32 have the unique five-layer stack construction described above.

As illustrated in FIG. 5, the vertical seam or seams 32 can be covered by a decorative cover strip 52 disposed on the exterior surface of the panel 14. The top edge 20 of the panel 14 and the bottom edge 22 of the panel 14 can also be covered with a cover strip 52. In typical embodiments, the cover strip or strips 52 are strips of braiding or strips of fringe material.

By the unique design of the invention, lamp shade slip covers 10 of the invention conform smoothly to the contours of a lamp shade 34 of similar shape. The slip cover material does not wrinkle, nor does it show lumps. Moreover, the one or more vertical seams used in the slip covers remain flat and do not pucker.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A lamp shade slip cover comprising a continuous loop of material, the continuous loop of material comprising a flexible panel having a first surface, a second surface, a top edge, a bottom edge and opposed first and second sides having respective first and second side edges, the first and second side edges being joined to one another along a first vertical seam, the first vertical seam comprising a five-layer stack wherein a single fold of the first side provides two of the five layers and a double fold of the second side provides the additional three layers.

2. The lamp shade slip cover of claim 1 wherein the first surface is the interior surface of the panel and the second surface is the exterior surface of the panel.

3. The lamp shade slip cover of claim 1 wherein the first vertical seam is covered with a cover strip on the second surface of the panel.

4. The lamp shade slip cover of claim 3 wherein the cover slip is a strip of braiding.

5. The lamp shade slip cover of claim 3 wherein the cover slip is a strip of fringe.

6. The lamp shade slip cover of claim 2 wherein the top edge of the panel is folded flat against the second surface of the panel and sewn thereto.

7. The lamp shade slip cover of claim 6 wherein the top edge is covered with a cover strip.

8. The lamp shade slip cover of claim 2 wherein the bottom edge of the panel is folded flat against the second surface of the panel and sewn thereto.

9. The lamp shade slip cover of claim 8 wherein the bottom edge is covered with a cover strip.

10. A lamp shade slip cover comprising a continuous loop of material, the continuous loop of material comprising a flexible panel having a first surface, a second surface, a top edge, a bottom edge and opposed first and second sides having respective first and second side edges, the first and second side edges being joined to one another along a first vertical seam, the loop having an upper opening defining a first open area and a lower opening defining a second open area, the first open area being less than the second open area, the first vertical seam being formed by (i) disposing the first surface of the two opposed side edges in abutment to form a seam allowance, (ii) sewing through the seam allowance to join the two side edges together, (iii) folding the second side over the seam allowance so as to sandwich the seam allowance between the first and second sides and to form a four layer stack; (iv) sewing through the four layer stack to form a French seam, and (v) folding the second side back over the French seam and sewing the second side to the French seam to form a five layer stack.

11. The lamp shade slip cover of claim 10 wherein the first surface is the interior surface of the panel and the second surface is the exterior surface of the panel.

12. The lamp shade slip cover of claim 10 wherein the flexible panel comprises a plurality of vertical seams.

13. The lamp shade slip cover of claim 12 wherein the vertical seam, the top edge and the bottom edge are all covered with cover strips on the second surface.

14. The lamp shade slip cover of claim 12 wherein the cover strips are strips of braiding.

15. A lamp shade slip cover comprising a continuous loop of material, the continuous loop of material comprising a flexible panel having an interior surface, an exterior surface, a top edge, a bottom edge and opposed first and second sides having respective first and second side edges, the first and second side edges being joined to one another along a first vertical seam, the first vertical seam comprising a five-layer stack wherein a single fold of the first side provides two of the five layers and a double fold of the second side provides the additional three layers, the first vertical seam being covered by a cover strip.

16. The lamp shade slip cover of claim 15 wherein the cover slip is a strip of braiding.

17. The lamp shade slip cover of claim 15 wherein the top edge of the panel is folded flat against the second surface of the panel and sewn thereto.

18. The lamp shade slip cover of claim 17 wherein the top edge is covered with a cover strip.

19. The lamp shade slip cover of claim 15 wherein the bottom edge of the panel is folded flat against the second surface of the panel and sewn thereto.

20. The lamp shade slip cover of claim 19 wherein the bottom edge is covered with a cover strip.
